(19) United States
(12) Patent Application Publication
(10) Pub. No.: US 2016/0286223 A1
(43) Pub. Date: Sep. 29, 2016

(54) METHOD AND APPARATUS FOR PROCESSING PIXELS IN VIDEO ENCODING AND DECODING

(71) Applicant: SAMSUNG ELECTRONICS CO., LTD., Suwon-si (KR)

(72) Inventors: Jie CHEN, Beijing (CN); Elena ALSHINA, Seoul (KR)

(73) Assignee: SAMSUNG ELECTRONICS CO., LTD., Suwon-si (KR)

(21) Appl. No.: 15/180,605

(22) Filed: Jun. 13, 2016

Related U.S. Application Data
(63) Continuation of application No. PCT/KR2014/012287, filed on Dec. 12, 2014.

(30) Foreign Application Priority Data
Dec. 13, 2013 (CN) 201310684138.3

(51) Int. Cl. H04N 19/182; H04N 19/174; H04N 19/117

(52) U.S. Cl. CPC H04N 19/182; H04N 19/117; H04N 19/174

(57) ABSTRACT

The present disclosure provides a method of processing pixels in video encoding and decoding, the method including determining a current sample offset processing region and performing classification and offset operations on pixels of the current sample offset processing region, wherein the determining of the current sample offset processing region includes performing a spatial position movement operation on a predetermined coding processing unit and determining a region after the spatial position movement operation as the current sample offset processing region. By using the present disclosure, the sample offset processing regions may be flexibly acquired and the encoding performance may be improved.

### TECHNICAL FIELD

The present disclosure relates to video encoding and decoding, and more particularly, to methods and apparatuses for processing pixels in video encoding and decoding.

### BACKGROUND ART

High-efficiency video coding (HEVC) is an international video coding standard that uses a sample adaptive offset technology to reduce distortion between original pixels and reconstructed pixels. In the technology, pixels of a region are classified by category and an offset value is added to the pixel. A process of classifying the pixels in the region and adding the offset value to the pixel needs to be performed in both an encoder and a decoder. In addition, the encoder needs to transmit information about offset values added to pixels of different categories in a bitstream and about a classification method used, but does not need to transmit information about pixels included in each category. After acquiring a current classification method, in order to obtain the same classification result as acquired by the encoder, the decoder will use the same classification method as used by the encoder to divide pixels in a current region. Next, the pixels are offset according to the categories of the pixels and the offset value transmitted in the bitstream. The pixel classification method has two modes, i.e., an edge mode and a band mode.

In the edge mode, the value of a current pixel is compared with the values of adjacent pixels of the current pixel, and the category of the current pixel is determined according to a result of the comparison. In an image, a pixel has several adjacent pixels. However, in practice, only some of the adjacent pixels are selected for comparison. When other adjacent pixels are selected, different classification results will be obtained. Thus, the edge mode classification method has various different pixel classification submethods corresponding to the selection of adjacent pixels for comparison. As illustrated in FIG. 1, the HEVC adopts four types of adjacent pixel selection methods. In the drawings, “c” denotes a current pixel and “a” and “b” denote selected adjacent pixels. Table 1 illustrates classification conditions in the edge mode. As illustrated in Table 1, when “c” is smaller than “a” and “c” is smaller than “b”, “c” belongs to Category 1; when “c” is smaller than “a” and “c” is equal to “b” or when “c” is smaller than “b” and “c” is equal to “a”, “c” belongs to Category 2; when “c” is greater than “a” and “c” is equal to “b” or when “c” is greater than “b” and “c” is equal to “a”, “c” belongs to Category 3; when “c” is smaller than “a” and “c” is greater than “b”, “c” belongs to Category 4; and when none of the above four conditions are satisfied, “c” belongs to Category 0.

TABLE 1
Classification Condition in Edge Mode of HEVC

| Category | Condition |
|---|---|
| 1 | c < a && c < b |
| 2 | (c < a && c == b) \|\| (c == a && c < b) |
| 3 | (c > a && c == b) \|\| (c == a && c > b) |
| 4 | c > a && c > b |
| 0 | None of the above |

In the band mode, the current pixel is directly classified according to the value of the current pixel. In the band mode, the entire range of pixel values is divided into several subsections (named bands in the HEVC), and an index of the subsection where the current pixel is located is a category number of the current pixel. As illustrated in Table 2, for a video sequence of 8 bits in the HEVC, a range of pixel values 0 to 255 is uniformly divided into 32 subsections with each subinterval having a length of 8, and the category of the current pixel is determined directly according to the value of the current pixel.

TABLE 2
Classification Method in Band Mode of HEVC

| Category | Pixel Values |
|---|---|
| 0 | 0~7 |
| 1 | 8~15 |
| 2 | 16~23 |
| 3 | 24~31 |
| 4 | 32~39 |
| 5 | 40~47 |
| 6 | 48~55 |
| 7 | 56~63 |
| 8 | 64~71 |
| 9 | 72~79 |
| 10 | 80~87 |
| 11 | 88~95 |
| 12 | 96~103 |
| 13 | 104~111 |
| 14 | 112~119 |
| 15 | 120~127 |
| 16 | 128~135 |
| 17 | 136~143 |
| 18 | 144~151 |
| 19 | 152~159 |
| 20 | 160~167 |
| 21 | 168~175 |
| 22 | 176~183 |
| 23 | 184~191 |
| 24 | 192~199 |
| 25 | 200~207 |
| 26 | 208~215 |
| 27 | 216~223 |
| 28 | 224~231 |
| 29 | 232~239 |
| 30 | 240~247 |
| 31 | 248~255 |

After the pixel classification result is acquired, the current pixel is offset according to the category of the current pixel. Herein, “being offset” may be understood as “adding an offset value”. The same offset is added to the pixels of the same category. In the edge mode, for pixel value processing, the offset values transmitted in the bitstream are added to the pixels of Category 1, Category 2, Category 3, and Category 4, and no offset value is added to the pixels of Category 0. Thus, the values of the pixels of Category 0 are maintained in an unchanged state. In the band mode, the encoder designates four consecutive offset subsections and adds the offset values to the pixels of the four consecutive offset subsections in order to obtain the processed pixel values. Also, for the pixels of other subsections, the processed pixel values are maintained in an unchanged state.

When this technology is used, the information needing to be transmitted in the bitstream includes classification information and offset information. The classification information includes an indication for indicating whether the edge mode or the band mode is used and an indication for indicating whether a classification submethod is used when the edge mode is used. The offset information includes four offset values when the edge mode is used, or includes an indication for indicating a start offset subsection and four offset values when the band mode is used.

The currently-written audio video coding standard AVS2 also uses the above sample adaptive offset technology, but it is different from the HEVC in certain details.

In the sample adaptive offset technology, the pixels of a designated region are determined as a processing unit in order to perform classification and offset operations. In the HEVC, the largest coding unit is determined as the processing unit and it is processed according to an order. In this case, the decoder first processes the pixels in the first largest coding unit according to the first group about the sample adaptive offset information of the bitstream, processes the pixels in the second largest coding unit according to the second group about the sample adaptive offset information of the bitstream, and continues the processing up to the last largest coding unit. In this way, the boundary of the processing unit processed each time by sample adaptive offset processing is adjusted according to the boundary of the largest coding unit.

However, in video encoding and decoding processing, the sample adaptive offset processing is performed after deblocking filtering. The deblocking filtering is a technology for processing the pixels at the boundary between two adjacent encoding processing blocks, and it may not be performed until the reconstructed values of the pixels are obtained on both sides of the boundary between two blocks. Thus, when the reconstruction of a current encoding processing block is completed, a deblocking filter may process only the pixels of the left boundary and the pixels of the top boundary of the current encoding processing block. However, since the reconstruction of the bottom adjacent encoding processing block and the right adjacent encoding processing block of the current encoding processing block is not yet completed, the deblocking filter may not process the pixels of the right boundary and the pixels of the bottom boundary of the current encoding processing block. Thus, in the actual deblocking filtering processing, when the reconstruction of the current encoding processing block is completed, the deblocking filter processes not only the pixels of the left boundary and the pixels of the top boundary of the current encoding processing block but also the pixels on the right boundary of the left adjacent encoding processing block and the pixels on the bottom boundary of the top adjacent encoding processing block.

As described above, when the reconstruction of the current encoding processing block is completed, deblocking filtering may be performed for the pixels on the right boundary and the pixels on the bottom boundary of the current encoding processing block. Since the sample adaptive offset processing is performed after the deblocking filtering, the sample adaptive offset processing may not be performed for any pixels. Thus, according to the effect of the deblocking filtering, a pixel region where the sample adaptive offset processing is actually performed tends not to be aligned with the encoding processing block. For example, as illustrated in FIG. 2, a block A, a block B, a block C, and a block D are coding units, and the block D is a current coding unit. When the block D is reconstructed, since the sample adaptive offset processing may not be performed for the pixels on the right boundary and the pixels on the bottom boundary of the block D, a region where the current sample adaptive offset processing is performed is a block E indicated by a dotted line in FIG. 2. Obviously, the block E is not aligned with the block D, but overlaps with the block A, the block B, the block C, and the block D. The overlapping regions are a subblock a, a subblock b, a subblock c, and a subblock d. In the HEVC standard, the largest coding unit is determined as a sample adaptive offset processing unit. In this case, when the block A, the block B, the block C, and the block D belong to different largest coding units, they may have different sample adaptive offset parameters (the sample adaptive offset parameters include classification methods and offset values). In this case, the subblock a, the subblock b, the subblock c, and the subblock d may have different sample adaptive offset processing parameters and may need to be processed differently. This increases the processing complexity of a codec. Since the values of the pixels on the bottom boundary and the pixels on the right boundary of the block D are not yet deblocking-filtered, the encoder may not clearly predict the optimal sample adaptive offset parameters for processing these pixels causing the encoding performance degradation.

In addition, image regions having different features may have different requirements for the sample adaptive offset processing unit. For example, for a flat image region, the sample adaptive offset processing needs to be performed in a large region; and for a region where the value of pixels changes rapidly, the sample adaptive offset processing needs to be performed in a small region. In the sample adaptive offset processing of the HEVC, the characteristics of an input image are not considered, and the processing is not flexible because the largest coding unit is always determined as the sample adaptive offset processing unit.

In the current HEVC, in the case of using the band mode, information of a start offset subsection needs to be transmitted in a bitstream, and thereafter an offset operation is performed for four subsections starting with the start offset subsection.

### DETAILED DESCRIPTION OF THE INVENTION

### Technical Solution

The present disclosure provides a video encoding and decoding pixel processing method and apparatus that may reduce the implementation complexity and improve the coding performance by dividing an image flexibly into sample offset processing regions in the processing process. By using a new offset method proposed by the present disclosure, the bit rate may be saved and the encoding performance may be improved.

In order to achieve this object, the present disclosure provides the following technical configuration.

A method of processing pixels in video encoding and decoding may include: performing a spatial position movement operation for a predetermined coding processing unit and determining the spatial position movement operation as a current sample offset processing region; and performing classification and offset operations for pixels of the current sample offset processing region.

Preferably, when the current sample offset processing region exceeds a boundary of a slice or an image, the current sample offset processing region may be reduced inside the boundary of the slice or the image and then the classification and offset operations may be performed; when the current sample offset processing region is determined to be acquired by moving a coding processing unit at the boundary of the slice or the image to an inside of the slice or the image, the current sample offset processing region may be expanded to the boundary of the slice or the image; and/or when the current sample offset processing region is determined to be acquired by moving the coding processing unit at the boundary of the slice or the image to the inside of the slice or the image, the current sample offset processing region may be maintained in an unchanged state and a pixel region between the boundary of the slice or the image and the current sample offset processing region may be determined as a region where the classification and offset operations are not performed or may be determined as an independent sample offset processing region where the classification and offset operations are performed.

Preferably, the predetermined coding processing unit may be a prediction unit, a prediction unit group including several adjacent prediction units, a transformation unit, a transmission unit group including several adjacent transformation units, a coding unit, a coding unit group including several adjacent coding units, a largest coding unit, or a largest coding unit group including largest coding units.

Preferably, the predetermined coding processing unit may be determined by a standard or a system or be transmitted in a bitstream; a movement direction in the spatial position movement operation may be determined by the standard or the system or be transmitted in the bitstream; and/or a movement distance in the spatial position movement operation may be determined by the standard or the system or be transmitted in the bitstream.

Preferably, the performing of the classification operation for the pixels of the current sample offset processing region may include: dividing a range of pixel values into N subsections; and classifying current pixels of a category corresponding to a subsection k in which a value of the current pixel is located, wherein N may be a predetermined positive integer and k may be an index of the subsection.

Preferably, the performing of the classification operation for the pixels of the current sample offset processing region may include: comparing a value of a current pixel and some or all of adjacent pixels of the current pixel; and determining a category of the current pixel according to a result of the comparing.

Preferably, the performing of the offset operation for the pixels of the current sample offset processing region may include adding an offset value to pixels of a category according to the category of the pixels.

Preferably, the performing of the offset operation for the pixels of the current sample offset processing region may include calculating the offset value corresponding to the category according to a predetermined calculation method based on an offset reference value.

A method of processing pixels in video encoding and decoding may include: determining a current sample offset processing region; and performing classification and offset operations for pixels of the current sample offset processing region.

In the method, the current sample offset processing region may be determined according to region information transmitted in a bitstream.

Preferably, an encoder and a decoder may determine several region division methods for a coding processing unit and allocate an index to each region division method. The region information transmitted in the bitstream may be the index of the region division method selected by the encoder.

Preferably, the coding processing unit may be a prediction unit, a prediction unit group including several adjacent prediction units, a transformation unit, a transformation unit group including several adjacent transformation units, a coding unit, a coding unit group including several adjacent coding units, a largest coding unit, or a largest coding unit group including several largest coding units.

Preferably, the coding processing unit may be determined by a standard or a system or be transmitted in a bitstream.

Preferably, when the current sample offset processing region is determined to exceed a boundary of a slice or an image, the current sample offset processing region may be reduced inside the boundary of the slice or the image and then the classification and offset operations may be performed; when the current sample offset processing region is determined to be acquired by moving a coding processing unit at the boundary of the slice or the image to an inside of the slice or the image, the current sample offset processing region may be expanded to the boundary of the slice or the image; and/or when the current sample offset processing region is determined to be acquired by moving the coding processing unit at the boundary of the slice or the image to the inside of the slice or the image, the current sample offset processing region may be maintained in an unchanged state and a pixel region between the boundary of the slice or the image and a boundary of the current sample offset processing region may be determined as a region where the classification and offset operations are not performed or may be determined as an independent sample offset processing region where the classification and offset operations are performed.

Preferably, the performing of the classification operation for the pixels of the current sample offset processing region may include: dividing a range of values of pixels into N subsections; and classifying a current pixel as a category corresponding to a k subsection in which a value of the current pixel is located, wherein N may be a predetermined positive integer and k may be an index of the subsection.

Preferably, the performing of the classification operation for the pixels of the current sample offset processing region may include: comparing a value of a current pixel and some or all of adjacent pixels of the current pixel; and determining a category of the current pixel according to a result of the comparing.

Preferably, the performing of the offset operation for the pixels of the current sample offset processing region may include adding an offset value to pixels of a category according to the category of the pixels.

Preferably, the performing of the offset operation for the pixels of the current sample offset processing region may include calculating the offset value corresponding to the category according to a predetermined calculation method based on an offset reference value.

A method of processing pixels in video encoding and decoding may include: determining a current sample offset processing region; and performing classification and offset operations for pixels of the current sample offset processing region. In the method, the performing of the classification operation for the pixels may include dividing a range of values of pixels into N subsections and classifying a current pixel as a category corresponding to a k subsection in which a value of the current pixel is located, where N may be a predetermined positive integer and k may be an index of the subsection; and the performing of the offset operation for the pixels may include determining M subsections needing to be offset according to the pixels of the current sample offset processing region and offsetting the pixels of the M offset subsections.

Preferably, the subsections needing to be offset may be determined according to the pixels included in all the subsections after the classification.

Preferably, the determining of the subsections needing to be offset according to the pixels included in all the subsections after the classification may include selecting M subsections including the most pixels among all the subsections after the classification as the offset subsections.

Preferably, the subsections needing to be offset may be determined according to the pixels included in all the subsections after the classification and information transmitted in a bitstream.

Preferably, the subsections needing to be offset may be determined according to a subsection including the most pixels of all the subsections after the classification and information on an offset subsection selection method appearing on the bitstream.

An apparatus for processing pixels in video encoding and decoding may include a processing region determining unit, a classification and offset information acquiring unit, a classifying unit, and an offsetting unit.

The processing region determining unit may perform a spatial position movement operation for a predetermined coding processing unit and determine a region after the spatial position movement operation as a current sample offset processing region; the classification and offset information acquiring unit may acquire a pixel classification method and corresponding offset values; the classifying unit may classify each pixel of the current sample offset processing region according to the pixel classification method determined by the classification and offset information acquiring unit; and the offsetting unit may offset the pixels according to the offset values and a result of the classifying by the classifying unit.

Preferably, the apparatus may further include a processing region modifying unit, when the current sample offset processing region exceeds a boundary of a slice or an image, reducing the current sample offset processing region determined by the processing region determining unit inside the boundary of the slice or the image and notifying the same to the classifying unit and the offsetting unit.

Preferably, the apparatus may further include a processing region modifying unit: when the current sample offset processing region is acquired by moving a coding processing unit at a boundary of a slice or an image to an inside of the slice or the image, expanding the current sample offset processing region determined by the processing region determining unit to the boundary of the slice or the image and notifying the same to the classifying unit and the offsetting unit; or when the current sample offset processing region is acquired by moving the coding processing unit at the boundary of the slice or the image to the inside of the slice or the image, maintaining the current sample offset processing region determined by the processing region determining unit in an unchanged state and notifying the classifying unit and the offsetting unit that sample offset processing is not performed for pixels of a region between the boundary of the slice or the image and a boundary of the current sample offset processing region or notifying the classifying unit and the offsetting unit that the region between the boundary of the slice or the image and the boundary of the current sample offset processing region is determined as an independent sample offset processing region.

An apparatus for processing pixels in video encoding and decoding may include a processing region determining unit, a classification and offset information acquiring unit, a classifying unit, and an offsetting unit. The processing region determining unit may determine a current sample offset processing region according to region information transmitted in a bitstream; the classification and offset information acquiring unit may acquire a pixel classification method and corresponding offset values; the classifying unit may classify each pixel of the current sample offset processing region according to the pixel classification method determined by the classification and offset information acquiring unit; and the offsetting unit may offset the pixels according to the offset values and a result of the classifying by the classifying unit.

Preferably, the apparatus may further include a processing region modifying unit, when the current sample offset processing region exceeds a boundary of a slice or an image, reducing the current sample offset processing region determined by the processing region determining unit inside the boundary of the slice or the image and notifying the same to the classifying unit and the offsetting unit.

Preferably, the apparatus may further include a processing region modifying unit: when the current sample offset processing region is acquired by moving a coding processing unit at a boundary of a slice or an image to an inside of the slice or the image, expanding the current sample offset processing region determined by the processing region determining unit to the boundary of the slice or the image and notifying the same to the classifying unit and the offsetting unit; or when the current sample offset processing region is acquired by moving the coding processing unit at the boundary of the slice or the image to the inside of the slice or the image, maintaining the current sample offset processing region determined by the processing region determining unit in an unchanged state and notifying the classifying unit and the offsetting unit that sample offset processing is not performed for pixels of a region between the boundary of the slice or the image and a boundary of the current sample offset processing region or notifying the classifying unit and the offsetting unit that the region between the boundary of the slice or the image and the boundary of the current sample offset processing region is determined as an independent sample offset processing region.

An apparatus for processing pixels in video encoding and decoding may include a processing region determining unit, a classification and offset information acquiring unit, a classifying unit, and an offsetting unit. The processing region determining unit may determine a current sample offset processing region. The classification and offset information acquiring unit may acquire a pixel classification method and corresponding offset values. The classifying unit may divide a range of values of pixels into N subsections and classify a current pixel as a category corresponding to a subsection k in which a value of the pixel is located, where N may be a predetermined positive integer and k may be an index of the subsection. The offsetting unit may offset the pixels according to the offset values and a classification result of the classifying unit. Herein, the offsetting of the pixels may include determining M subsections needing to be offset according to the pixels of the current sample offset processing region and then offsetting the pixels of the M offset subsections.

Preferably, the offsetting unit may determine the M subsections needing to be offset according to the pixels included in all the subsections after the classification.

Preferably, the offsetting unit may select M subsections including the most pixels among all the subsections after the classification as the offset subsections.

Preferably, the offsetting unit may determine the M subsections needing to be offset according to the pixels included in all the subsections after the classification and information transmitted in a bitstream.

Preferably, the classification and offset information acquiring unit may acquire information about an offset subsection selection method from the bitstream; and the offsetting unit may determine the subsections needing to be offset according to a subsection including the most pixels of all the subsections after the classification and the information about the offset subsection selection method transmitted in the bitstream.

In view of the above technical solution, in the present disclosure, the predetermined coding processing unit may be moved in the predetermined movement direction; the region after the spatial position movement operation may be determined as the current sample offset processing region; and the classification and offset operations may be performed for all the pixels of the current sample offset processing region. With the above method, the determined sample offset processing region may not be completely aligned with the coding processing unit, but there may be any position difference between the sample offset processing region and the coding processing unit such that the sample offset processing regions may be acquired more flexibly; the movement direction and the movement distance may be selected according to requirements; and particularly, for encoding performance improvement, it may coincide with a deblocking filtering region in the case of movement to the top left side in order to reduce the execution cost and improve the prediction accuracy of the sample offset parameters.

Also, in order to determine the sample offset processing regions, the present disclosure may provide a processing method in which the shape and size of the sample offset processing regions are specified in the bitstream transmitted by the encoder; and for other image regions, the shape and size of other sample offset processing regions may be adopted to satisfy the requirements of other sample offset processing units.

Also, the present disclosure may provide a new sample offset method. In the above method, the encoder does not need to transmit or may transmit less information about the offset subsections, and the decoder may derive the information of the offset subsections according to the distribution of the pixels of the current sample processing region in order to save the bit rate and improve the encoding performance.

### DESCRIPTION OF THE DRAWINGS

FIG. 1 is a schematic diagram illustrating positions of selected adjacent pixels and a current pixel for comparison in an edge mode in HEVC.

FIG. 2 is a schematic diagram illustrating a positional relationship between a current coding unit and a region where sample offset processing is actually performed.

FIG. 3 is a basic flow diagram illustrating a first type of a pixel processing method according to the present disclosure.

FIG. 4 is a detailed flow diagram illustrating pixel processing methods of Embodiments 1 to 4.

FIG. 5 is a schematic diagram illustrating a region where sample offset processing is performed in Embodiment 1.

FIG. 6 is a schematic diagram illustrating positions of selected adjacent pixels and a current pixel in an edge mode classification method.

FIG. 7 is a schematic diagram illustrating sample offset processing regions in Embodiment 2.

FIG. 8 is a schematic diagram illustrating sample offset processing regions in Embodiment 3.

FIG. 9 is a schematic diagram illustrating sample offset processing regions in Embodiment 4.

FIG. 10 is a flow diagram illustrating a pixel processing method in relation to FIG. 5.

FIG. 11 is a schematic diagram illustrating sample offset processing regions in Embodiment 5.

FIG. 12 is a schematic diagram illustrating a basic flow of a second type of a pixel processing method according to the present disclosure.

FIG. 13 is a schematic diagram illustrating sample offset processing regions in Embodiment 6.

FIG. 14 is a schematic diagram illustrating sample offset processing regions in Embodiment 7.

FIG. 15 is a schematic diagram illustrating a basic flow of pixel processing methods in Embodiments 8 and 9 of the present disclosure.

FIG. 16 is a schematic diagram illustrating a basic configuration of a pixel processing apparatus according to the present disclosure.

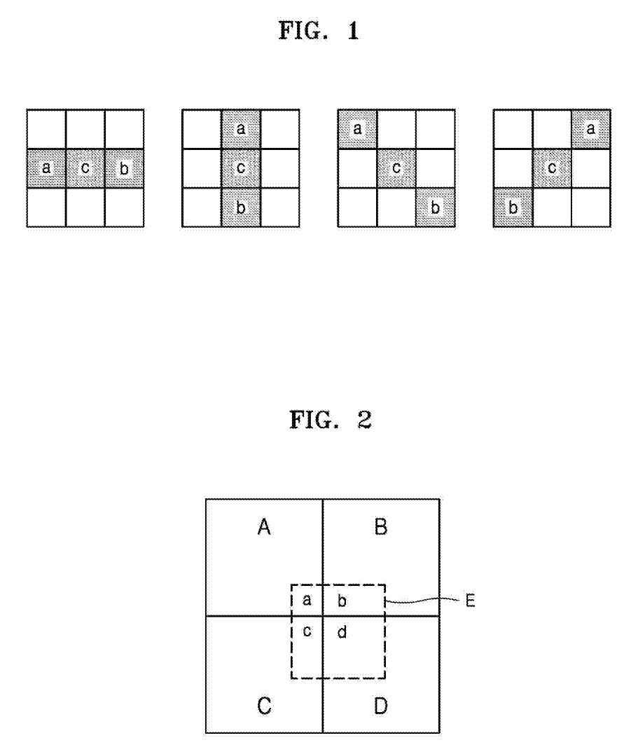

### MODE OF THE INVENTION

In order to clearly understand the technical means, objects, and advantages of the present disclosure, the present disclosure will be described in detail with reference to the accompanying drawings.

The present disclosure may provide three types of methods for processing pixels in video encoding and decoding. In the first type of the method, a spatial position movement operation for a coding processing unit may be performed to acquire a current sample offset processing region, and then the pixels of the region may be classified and offset. In the second type of the method, the shape and size of a current sample offset processing region may be specified in a bitstream, and then the pixels of the region may be classified and offset. In the third type of the method, after a current sample offset processing region is determined, the pixels of the current sample offset processing region may be classified by a band mode classification method, and then the subsections needing to be offset may be determined according to the distribution of the pixels of each subsection. The above methods will be described below in detail.

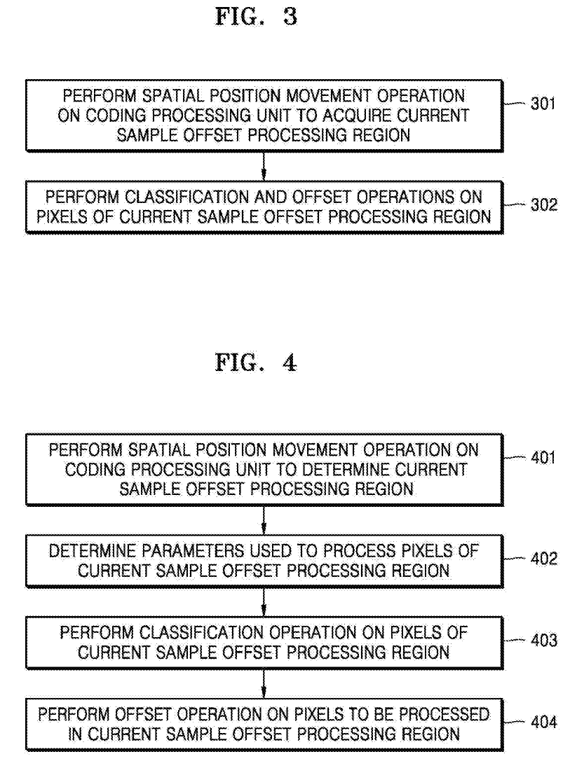

FIG. 3 is an overall flow diagram illustrating a first type of a pixel processing method according to the present disclosure. As illustrated in FIG. 3, the above method may include the following process.

In operation 301, a spatial position movement operation may be performed for a current coding processing unit to acquire a current sample offset processing region.

The coding processing unit on which the spatial position movement operation is performed may be a prediction unit, a transformation unit, a coding unit, a largest coding unit, a prediction unit group including several adjacent prediction units, a transformation unit group including several adjacent transformation units, a coding unit group including several adjacent coding units, or a largest coding unit group including several adjacent largest coding units. The coding processing unit may be determined according to the system settings or the coding standards or may be selected by the encoder properly according to the user requests and the image features, and information of the coding processing unit may be specified in a bitstream. In this way, the sample offset processing regions are not limited to the largest coding units in the HEVC, but may have other sizes and shapes according to other requirements and applications. By performing the spatial position movement operation for the coding processing unit, the sample offset processing region does not need to be completely aligned with the coding processing unit, and thus the actual execution complexity may be reduced. For example, when the coding processing unit is moved to the top left side, the sample offset processing region may coincide with a region where the deblocking filtering for reducing the execution complexity is actually performed.

When the spatial position movement operation is performed, it may be performed according to the predetermined movement direction and movement distance. The movement direction may be, for example, the top left side, the top side, or the left side. The top left side may represent the upward movement, and it may be specified by the system or the basic standard or may be specified in the bitstream.

In operation 302, the current sample offset processing region may be classified and offset.

Conventional methods may be used as the classification method and the offset method, and new classification methods and offset methods described below in detail may be provided by the present disclosure.

The flow of the first type of the pixel processing method according to the present disclosure has been described up to now.

The detailed execution of the flow illustrated in FIG. 3 will be described below with reference to various embodiments.

### Embodiment 1

According to an embodiment of the present disclosure, the largest coding unit is determined as the coding processing unit and the spatial position movement operation is performed.

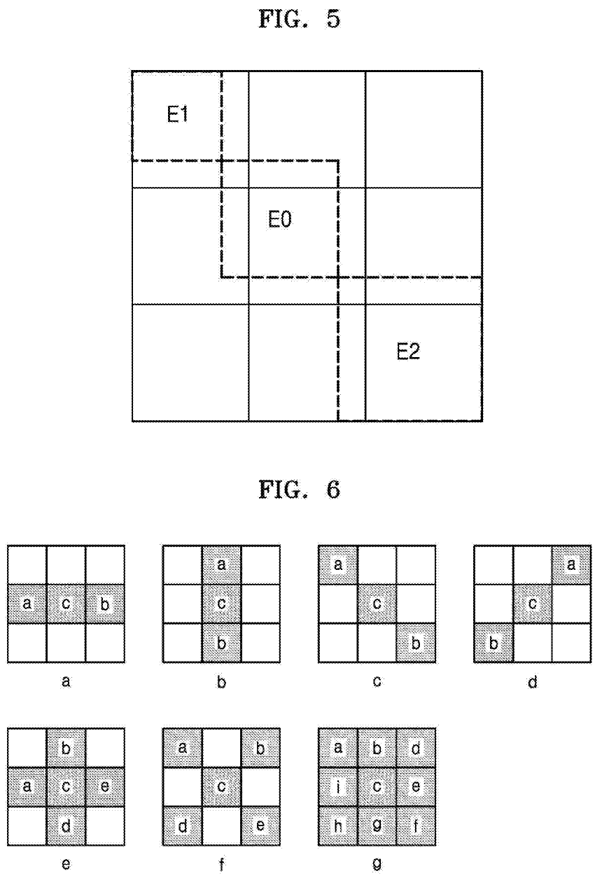

FIG. 4 is a flow diagram illustrating pixel processing methods according to Embodiments 1 to 4 of the present disclosure. The flow may include the following process.

In operation 401, the spatial movement operation may be performed on the coding processing unit to determine the current sample offset processing region.

In an embodiment of the present disclosure, the current sample offset processing region may be acquired by moving the current largest coding unit to the top left side by the distance of N pixels. Herein, “being moved to the top left side by the distance of N pixels” may represent “being moved to the left side by the distance of N pixels and then to the top side by the distance of N pixels”, and “N” may be specified when necessary. For example, “N” may be “4”. Specifically, the sample offset processing regions acquired after the movement operation are illustrated in FIG. 5, and the solid-line blocks are the largest coding units and the dotted-line blocks are the sample offset processing pixel regions. As illustrated in the block E0, the current sample offset processing pixel region may be directly acquired by moving the largest coding unit to the top left side by the distance of four pixels. Considering the general principle of encoding and decoding processing, when the region after the movement operation exceeds the boundary of a slice or an image as illustrated in the block E1, and/or when the region after the movement operation is acquired by moving the largest coding unit from the bottom boundary or the right boundary of the slice or the image to the inside of the slice or the image, the region may be automatically expanded to the boundary of the slice or the image as illustrated in the block E2. In this way, the above method may ensure that the number of largest coding units and the number of sample offset processing regions are equal and one-to-one correspond to each other. In an embodiment of the present disclosure, the block E2 may be acquired by moving the largest coding unit from the bottom boundary or the right boundary. Actually, for the sample offset processing region acquired by moving the coding processing unit from any boundary of a slice or an image to the inside of the slice or the image, the same processing may need to be performed to expand the region to the boundary of the slice or the image. The boundary for this processing needs to be determined by the movement direction.

In operation 402, parameters used to process the pixels in the current sample offset processing region may be determined.

The parameters may include a pixel classification method and offset values. The encoder may determine the classification method and the offset values according to actual states and may encode the selected parameters in the bitstream. In operation 403, the pixels of the current sample offset processing region may be classified.

The pixels of the current sample offset processing region may be classified according to the pixel classification method determined in operation 402. Specifically, a possible pixel classification method may be a horizontal-pattern edge mode classification method. FIG. 6 is a schematic diagram illustrating the positions of a current pixel and selected adjacent pixels in an edge mode classification method. In FIG. 6, a subdiagram “a” illustrates a schematic diagram of the pixel positions in the horizontal-pattern edge mode classification method in which the current pixel “c” is compared with the right and left adjacent pixels “a” and “b” in order to acquire the classification result according to Table 1.

In operation 404, the pixels to be processed in the current sample offset processing region may be offset.

The offset processing for the pixels may be performed by determining the category of the pixels as one unit. That is, the same offset value may be added to the pixels belonging to the same category according to the classification result of operation 403. However, the number of offset values may be smaller than the number of pixel categories. In this case, only the pixels included in some of the pixel categories may be offset, and the pixel categories needing to be offset may be specified in the standard or may be specified in the bitstream. Specifically, a possible offset processing method may add the corresponding offset values to the pixels belonging to Category 1, Category 2, Category 3, and Category 4, and may not perform any operation for the pixels belonging to Category 0.

The order of operation 401 and operation 402 may vary according to embodiments.

### Embodiment 2

According to an embodiment of the present disclosure, a group of several largest coding units may be determined as the coding processing unit, and then the spatial position movement operation may be performed.

Referring to FIG. 4, the flow of a pixel processing method according to an embodiment of the present disclosure may include the following process.

In operation 401, the spatial position movement operation may be performed on the coding processing unit to determine the current sample offset processing region.

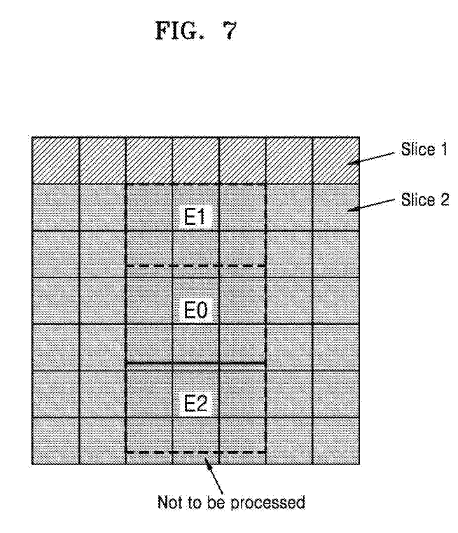

In an embodiment of the present disclosure, the current sample offset processing region may be acquired by moving a group of several adjacent largest coding units by the distance of eight pixels. FIG. 7 is a schematic diagram illustrating sample offset processing regions of the present disclosure. As illustrated in FIG. 7, the solid-line blocks may be the largest coding units and the dotted-line blocks may be the sample offset processing regions. Six largest coding units including three horizontal largest coding units and two vertical largest coding units may be determined as a coding processing unit. As illustrated in the block E0, the coding processing unit may be determined as one unit that is moved to the top side by the distance of eight pixels in order to acquire the current sample offset processing region. Considering the general principle of video encoding and decoding, preferably, when the region after the movement operation exceeds the boundary of a slice or an image, it should be automatically reduced to the boundary of the slice or the image as illustrated in the block E1; and/or when the region after the movement operation is acquired by moving the largest coding unit group from the bottom boundary of the slice or the image to the inside of the slice or the image, the region may be maintained in an unchanged state as illustrated in the block E2, and in this case, there may be a pixel region between the bottom boundary of the region after the movement operation and the bottom boundary of the slice or the image where the sample offset processing is not performed. This method may ensure that the number of processed pixel regions and the number of largest coding unit groups are equal and one-to-one correspond to each other.

In addition, as in Embodiment 1, in the present embodiment, the block E2 may be acquired by moving the largest coding unit group from the bottom boundary of the slice or the image. Actually, for the sample offset processing region acquired by moving the coding processing unit from any boundary of a slice or an image to the inside of the slice or the image, the same processing may need to be performed without being limited to the bottom boundary (that is, the expansion may not be performed for the block E2, and the sample offset processing may not need to be performed for the region between the boundary of the sample offset processing region and the boundary of the slice or the image). Also, the boundary for this processing may need to be determined by the movement direction.

In operation 402, parameters used to process the pixels of the current sample offset processing region may be determined.

The processing of the present operation may be the same as the processing of Embodiment 1, and thus descriptions thereof will be omitted herein.

In operation 403, the pixels of the current sample offset processing region may be classified.

The pixels of the current sample offset processing region may be classified according to the pixel classification method determined in operation 402. Specifically, a possible pixel classification method may be an edge mode classification method of a diagonal pattern with an angle of 45 degrees. As illustrated in a subdiagram “d” of FIG. 6, the current pixel “c” may be compared with the adjacent pixel “a” of the top left side and the adjacent pixel “b” of the bottom right side, and the classification result may be acquired according to Table 1.

In operation 404, the pixels to be processed in the current sample offset processing region may be offset.

Specifically, a possible offset adding method may add the corresponding offset values to the pixels of Category 1, Category 2, Category 3, and Category 4, and may not perform any operation for the pixels of Category 0.

The order of operation 401 and operation 402 may vary according to embodiments.

### Embodiment 3

According to an embodiment of the present disclosure, the coding unit may be determined as the coding processing unit and the spatial position movement operation may be performed.

As illustrated in FIG. 4, the flow of the pixel processing method in the present embodiment may include the following process.

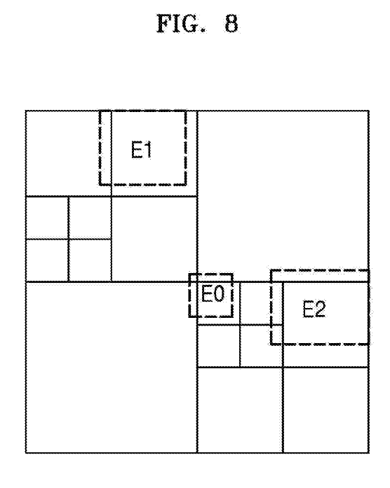

In an embodiment of the present disclosure, the current sample offset processing region may be acquired by moving the current coding unit to the top left side by the distance of two pixels, for example, by moving the current coding unit to the left side by the distance of two pixels and then to the top side by the distance of two pixels. FIG. 8 is a schematic diagram illustrating sample offset processing regions in an embodiment of the present disclosure. As illustrated in FIG. 8, the solid-line blocks may be the coding units and the dotted-line blocks may be the sample offset processing regions. As illustrated in the block E0, the current sample offset processing region may be directly acquired by moving the current coding unit to the top left side by the distance of two pixels. Considering the general principle of video encoding and decoding processing, in general, the encoding and decoding processings for different slices may be independent of each other. Thus, preferably, when the region after the movement operation exceeds the boundary of a slice or an image, it may be automatically reduced inside the boundary of the slice or the image as illustrated in the block E1; and/or when the region after the movement operation is acquired by moving the coding unit at the bottom boundary or the right boundary of the slice or the image, the region after the movement operation may be automatically reduced inside the boundary of the slice or the image as illustrated in the block E2. This method may ensure that the number of sample offset processing regions and the number of coding units are equal and one-to-one correspond to each other. In this case, the sizes of the respective sample offset processing regions may be different from each other.

In operation 402, parameters for processing the pixels in the current sample offset processing region may be determined.

The processing of the present operation may be the same as the processing of Embodiment 1, and will not be described herein.

In operation 403, the pixels of the current sample offset processing region may be classified.

The pixels of the current offset processing region may be classified according to the pixel classification method determined in operation 402. Specifically, a possible pixel classification method may be a band mode classification method. Specifically, a possible band mode classification method may include an operation of dividing a range of values of pixels uniformly into N subsections and an operation of determining a section including a current pixel according to a value of the current pixel. If the range of values of pixels is from 0 to max−1, the k^{th} range of subsections is from

$$k \times \frac{max}{N} to \frac{( k + 1 ) \times max}{N} - 1.$$

The value of N may be specified by the system or the standard. For example, “N” may be “16”.

In operation 404, the pixels to be processed in the current sample offset processing region may be offset. In an embodiment of the present disclosure, based on the classification method used in operation 403, when the pixels are offset in the present operation, the offset value may be added to the pixels of the subsection corresponding to the offset. In this method, the N offset values may need to be transmitted in the bitstream.

The order of operation 401 and operation 402 may vary according to embodiments.

### Embodiment 4

In an embodiment of the present disclosure, a group of several largest coding units may be determined as the coding processing unit, and then the spatial position movement operation may be performed.

As illustrated in FIG. 4, the flow of the pixel processing method in an embodiment of the present disclosure may include the following process.

In operation 401, the spatial position movement operation may be performed on the coding processing unit to determine the current sample offset processing region.

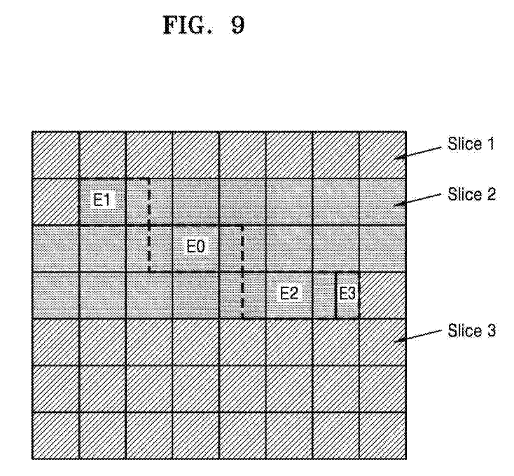

In an embodiment of the present disclosure, the current sample offset processing region may be acquired by moving a largest coding unit group including two adjacent largest coding units to the left side by the distance of 16 pixels. FIG. 9 is a schematic diagram illustrating sample offset processing regions in Embodiment 4. As illustrated in FIG. 9, the solid-line blocks may be the largest coding units and the dotted-line blocks may be the sample encoding processing pixel regions. As illustrated in the block E0, the current sample offset processing pixel region may be directly acquired by moving the two largest coding units to the left side by the distance of 16 pixels. Considering the general principle of encoding and decoding, the general encoding and decoding processings for different slices may be independent of each other. Thus, preferably, when the region after the movement operation exceeds the boundary of a slice or an image, it may be automatically reduced inside the boundary of the slice or the image as illustrated in the block E1; and/or the region after the movement operation may be acquired by moving the largest coding unit group from the right boundary of the slice or the image to the inside of the slice or the image. In this case, as illustrated in the block E3, the pixel region between the right boundary of the slice and the right boundary of the region after the movement operation may be determined as an independent sample offset processing region where the sample offset processing is performed. The above method may ensure that all the pixels of the image may be processed.

In an embodiment of the present disclosure, the decoder may need to decode the movement distance and the movement direction of the current sample offset processing region in the bitstream.

In operation 402, parameters used to process the pixels of the current sample offset processing region may be determined.

The processing of the present operation may be the same as the processing of Embodiment 1, and will not be described herein.

In operation 403, the pixels of the current sample offset processing region may be classified.

The pixels of the current sample offset processing region may be classified according to the pixel classification method determined in operation 402. Specifically, a possible pixel classification method may be a band mode classification method. Specifically, a possible band mode classification method may include an operation of dividing a range of values of pixels uniformly into 32 subsections and an operation of determining a section including a current pixel according to a value of the current pixel. If the range of values of pixels is from 0 to max−1, the range of k^{th} subsections is from

$$k \times \frac{max}{32} to \frac{( k + 1 ) \times max}{32} - 1.$$

When the value of the current pixel is greater than or equal to

$$k \times \frac{max}{32}$$

and smaller than or equal to

$$\frac{( k + 1 ) \times max}{32} - 1 ,$$

the current pixel may belong to the subsection “k”, for example, the category “k”.

In operation 404, the pixels to be processed in the current sample offset processing region may be offset.

Specifically, a possible offset processing method may include an operation of determining a subsection needing to be offset and an operation of adding an offset value corresponding to an offset subsection to the pixels of the subsection. Specifically, a possible method for determining the offset subsections may include classifying the 32 subsections acquired in operation 403 as center subsections and adjacent subsections, wherein the center subsections may include eighth to 23rd subsections, the adjacent subsections may include 0th to seventh subsections and 24th to 31st subsections, and one of the adjacent subsections or the center subsections may be selected as the offset subsections. An indication for indicating whether the center subsections or the adjacent subsections are selected as the offset subsections may be specified in the bitstream. Preferably, the encoder may select the offset subsections according to the encoding performance or cost.

The order of operation 401 and operation 402 may vary according to embodiments.

The four embodiments may provide detailed embodiments corresponding to the first type of the pixel processing method of the present disclosure. The spatial position movement operation may be performed on the coding processing unit to acquire the sample offset processing region. Various spatial position movement methods, pixel classification methods, and pixel offset methods may be properly combined, and the above embodiments are merely examples and do not limit the method of combination.

Also, in addition to being able to acquire the sample offset processing region by performing the spatial position movement operation on the coding processing unit, the movement operation may not be performed in some cases for simplicity. However, as illustrated in Embodiment 5, the size of the coding processing unit may be expanded to avoid the complexity caused by executing the sample offset processing after the deblocking filtering.

### Embodiment 5

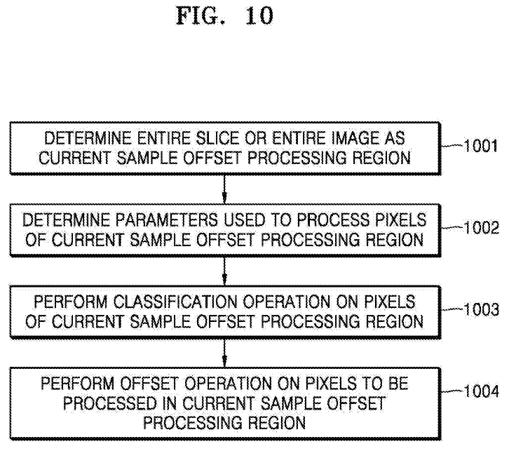

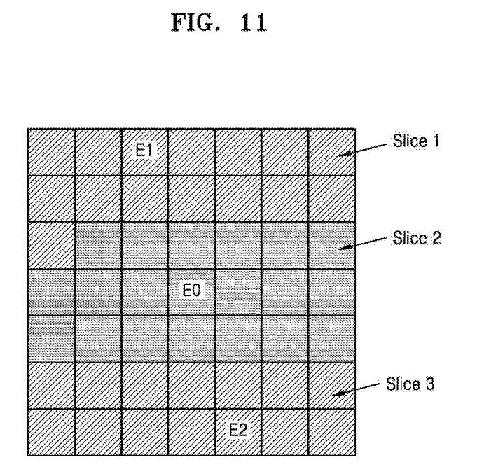

FIG. 10 is a detailed flow diagram illustrating a pixel processing method of Embodiment 5. As illustrated in FIG. 10, the above method may include the following process.

In operation 1001, the entire slice or the entire image may be determined as the current sample offset processing region.

Specifically, the current sample offset processing region may be the entire slice or the entire image, and the movement operation may not be performed. For example, the entire slice may be determined as the current offset processing region. FIG. 11 is a schematic diagram illustrating sample offset processing regions. As illustrated in FIG. 11, the current sample offset processing region may be illustrated as E0 representing the entire Slice 2. In this type of sample offset processing region determining method, the shape and size of each region determined according to how the current image is divided into slices may vary as illustrated in E1, E2, and E0. Thus, when one slice is determined as the sample offset processing region, no more problems will be caused by the non-coincidence between the sample offset processing region and the deblocking filtering region.

In operation 1002, parameters used to process the pixels of the current sample offset processing region may be determined.

The processing of the present operation may be the same as the processing of Embodiment 1, and will not be described herein.

In operation 1003, the pixels of the current sample offset processing region may be classified.

The pixels of the current offset processing region may be classified according to the pixel classification method determined in operation 1002. Specifically, a possible pixel classification method may be an edge mode classification method of a certain pattern. As illustrated in a subdiagram “e” of FIG. 6, the current pixel “c” may be compared with the adjacent pixel “a”, the adjacent pixel “b”, the adjacent pixel “d”, and the adjacent pixel “e”. When the value of “c” is greater than the value of “a”, greater than the value of “b”, greater than the value of “d”, and greater than the value of “e”, the current pixel “c” may belong to Category 1; when the value of “c” is smaller than the value of “a”, smaller than the value of “b”, smaller than the value of “d”, and smaller than the value of “e”, the current pixel “c” may belong to Category 2; and in the other cases, the current pixel “c” may belong to Category 3.

In operation 1004, the pixels to be processed in the current sample offset processing region may be offset.

Specifically, a possible offset processing method may subtract the absolute value of the offset from the pixels belonging to Category 1; add the absolute value of the offset to the pixels belonging to Category 2; and may not perform any processing for the pixels belonging to Category 3. In this type of the offset method, only the absolute values of the offsets may need to be transmitted in the bitstream.

The order of operation 1001 and operation 1002 may vary according to embodiments.

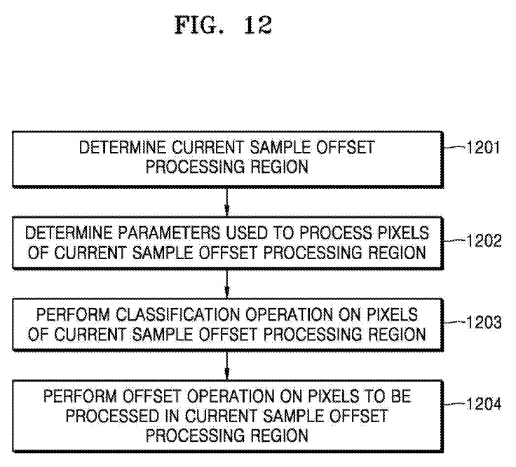

The second type of the pixel processing method of the present disclosure will be described below. FIG. 12 is a schematic diagram illustrating a flow of a second type of a pixel processing method of the present disclosure. As illustrated in FIG. 12, the above method may include the following process.

In operation 1201, the current sample offset processing region may be determined.

In view of encoding, the shape and size of the current sample offset processing region may be determined according to the actual requirements, and may be specified as the sample offset processing region information in the bitstream. In view of decoding, the current sample offset processing region may be determined according to the sample offset processing region information decoded from the bitstream. In addition, when the shape and size of the current sample offset processing region are specified in the bitstream, it may be completely described by the sample offset processing region information transmitted in the bitstream.

Alternatively, the possible shape and size of the sample offset processing region may be predefined and may be aligned accordingly; and in order to represent the adopted size and shape, the corresponding index may be transmitted in the bitstream.

In operation 1202, parameters used to process the pixels of the current sample offset processing region may be determined.

The processing of the present operation may be the same as the processing of Embodiment 1, and will not be described herein.

In operation 1203, the pixels of the current sample offset processing region may be classified.

The present operation may use the methods of Embodiments 1 to 5, and will not be described herein.

In operation 1204, the pixels to be processed in the current sample offset processing region may be offset.

The present operation may use the methods of Embodiments 1 to 5, and will not be described herein.

The order of operation 1201 and operation 1202 may vary according to embodiments.

Detailed embodiments of the second type of the pixel processing method will be described below.

### Embodiment 6

A detailed flow of the pixel processing method of the present disclosure will be described with reference to FIG. 12. As illustrated in FIG. 12, the above method may include the following process.

In operation 1201, the current sample offset processing region may be determined.

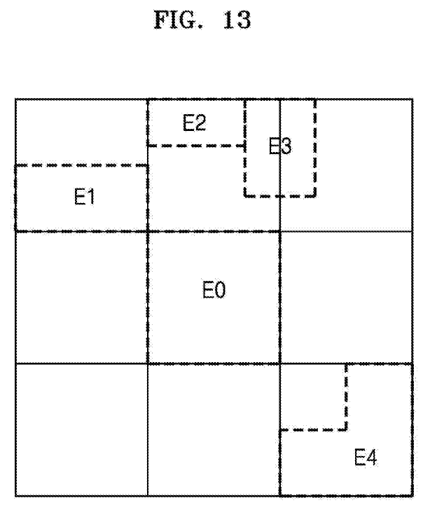

Specifically, in a possible method of operation 1201, the encoder may transmit the region information and the size of the current sample offset processing region in the bitstream, and the decoder may determine the current sample offset processing region according to the bitstream. FIG. 13 is a schematic diagram illustrating sample offset processing regions in an embodiment of the present disclosure. As illustrated in FIG. 13, the current sample offset processing region may be a square region of N×N pixels, for example, E0; may be a square region of N×M pixels, for example, E1, E2, and E3; or may be other shapes, for example, E4. A start point of each sample offset processing region may be determined according to an end point of the recent region, or information about the start point may be transmitted on the bitstream.

In operation 1202, parameters used to process the pixels of the current sample offset processing region may be determined.

The processing of the present operation may be the same as the processing of Embodiment 1, and will not be described herein.

In operation 1203, the pixels of the current sample offset processing region may be classified.

The pixels of the current sample offset processing region may be classified according to the pixel classification method determined in operation 1202. Specifically, a possible pixel classification method may be a band mode classification method. Specifically, a possible band mode classification method may include an operation of dividing a range of values of pixels into 32 subsections and an operation of determining a subsection including a current pixel according to a value of the current pixel. If the range of values of pixels is from 0 to max−1, the range of k^{th} subsections is from

$$k \times \frac{max}{32} to \frac{( k + 1 ) \times max}{32} - 1.$$

When the value of the current pixel is greater than or equal to

$$k \times \frac{max}{32}$$

and smaller than or equal to

$$\frac{( k + 1 ) \times max}{32} - 1 ,$$

the current pixel may belong to the subsection “k”, for example, the category “k”.

In operation 1204, the pixels to be processed in the current sample offset processing region may be offset.

Specifically, a possible offset processing method may include an operation of determining the subsections needing to be offset and an operation of adding an offset value corresponding to the offset subsection to the pixels of the subsection. Specifically, a possible method for determining the offset subsections may include an operation of determining a start subsection and an operation of determining N consecutive subsections starting from the start subsection as the offset subsections. After the offset subsections are determined, the offset values may be added to the pixels of the corresponding offset subsections. The start offset subsection may be specified in the bitstream. In this offset method, the bitstream may need to transmit the N offset values and the index of the start offset subsection.

The order of operation 1201 and operation 1202 may vary according to embodiments.

### Embodiment 7

FIG. 12 is a detailed flow diagram illustrating a pixel processing method of an embodiment of the present disclosure. As illustrated in FIG. 12, the above method may include the following process.

In operation 1201, the current sample offset processing region may be determined.

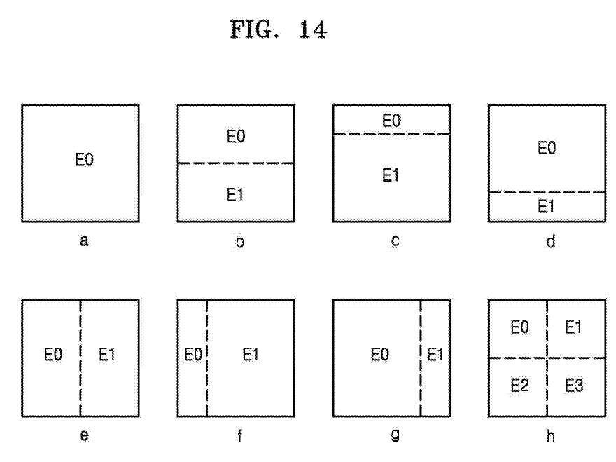

Specifically, in a possible method for determining the current sample offset processing region in operation 1201, the encoder may transmit the index of the size and shape information of the current sample offset processing region to the decoder in the bitstream. Specifically, the encoder and the decoder may predetermine various region classification methods for dividing the coding processing unit into one or more sample offset processing regions, and may allocate an index to each region division method accordingly. The index of the region division method selected by the encoder will be transmitted in the bitstream. Since the coding processing unit may be the same as the coding processing unit of the first type of the pixel processing method, it may be, for example, a prediction unit, a prediction unit group including several adjacent prediction units, a transformation unit, a transformation unit group including several adjacent transformation units, a coding unit, a coding unit group including several adjacent coding units, a largest coding unit, or a largest coding unit group including several largest coding units. The coding processing unit used for region division may be predetermined by the system or the standard or may be transmitted in the bitstream. FIG. 14 is a schematic diagram illustrating sample offset processing regions of the present disclosure. In FIG. 14, according to an embodiment, the largest coding unit may be determined as the coding processing unit, and the sample offset processing region may be acquired by dividing the largest coding unit. For example, when the index in the bitstream is 0, it may indicate that the current sample offset processing region is the entire largest coding unit; when the index value is 1, it may indicate that the largest coding unit is equally divided into the top sample offset processing region and the bottom sample offset processing region; when the index value is 2 or 3, it may indicate that the largest coding unit is horizontally divided into the top sample offset processing region and the bottom sample offset processing region that are not equal to each other; when the index value is 4, 5, or 6, it may indicate that the largest coding unit is vertically divided into two equal or unequal sample offset processing regions on the left side and the right side; and when the index value is 7, it may indicate that the largest coding unit is divided into four sample offset processing regions.

More generally, there may be other region division methods, and other predetermined coding processing units may be divided to obtain the current sample offset processing region.

In this method, the shape and size of each sample offset unit may seem to be different from each other.

In operation 1202, parameters used to process the pixel in the current sample offset processing region may be determined.

The processing of the present operation may be the same as the processing of Embodiment 1, and will not be described herein.

In operation 1203, the pixels of the current sample offset processing region may be classified.

The pixels of the current sample offset processing region may be classified according to the pixel classification method determined in operation 1202. Specifically, a possible pixel classification method may be a band mode classification method. Specifically, a possible band mode classification method may include an operation of dividing a range of values of pixels uniformly into N subsections and an operation of determining a section including a current pixel according to a value of the current pixel. The details of the division may be specified by the system or the standard. The range may be divided uniformly into N subsections or may be divided non-uniformly. When the non-uniform division is adopted, the start pixel and the end pixel of each subsection may be specified by the system or the standard.

In operation 1204, the pixels to be processed in the current sample offset processing region may be offset.

Specifically, a possible offset processing method may include an operation of determining the subsections needing to be offset and an operation of adding an offset value corresponding to the offset subsection to the pixels of the subsection. Furthermore, in a possible method for determining the offset subsections, the encoder may specify the subsections needing to be offset directly in the bitstream. After the offset subsections are determined, the offset values may be added to the pixels of the corresponding offset subsections. In this offset method, the bitstream may need to transmit M offset values and M offset subsection indexes, where M may be a predetermined positive integer.

The order of operation 1201 and operation 1202 may vary according to embodiments.

The above processing may be two detailed embodiments of the pixel processing method provided by the present disclosure. In this method, the more flexible sample offset processing region may be acquired. In order to be applied to other applications, the sample offset processing region is not limited to the largest coding unit. The sample offset processing region acquired by moving the coding processing unit to the top left side may coincide with an actual deblocking filtering region, thus avoiding the implementation complexity caused by the non-coincidence with the actual deblocking filtering region.

As described above, in the current band mode classification method of the HEVC, the information of the start offset subsection needs to be transmitted in the bitstream, thus requiring a considerable bit rate. According to the present disclosure, in order to save the bit rate and improve the encoding performance, the decoder may directly determine the subsections needing to be offset according to the pixels of all the subsections after the classification or may directly determine the subsections needing to be offset according to other information and the pixels of all the subsections after the classification. In this way, the less information of the offset subsections is transmitted in the bitstream, and thus the bit rates may be saved and the encoding performance may be improved.

Specifically, in three types of the pixel processing method, after the sample offset region is determined, a new offset method corresponding to the band mode classification method may be provided. Herein, in the state of not restricting the sample offset region determining method, a new offset method may be provided, and a certain method known prior to the present disclosure or the methods described in the present disclosure may be used. When the pixels are classified by the band mode classification method, the new offset method may be adopted. When the new offset method is used, the encoder and the decoder may first determine the subsections needing to be offset according to the pixels of each subsection after the classification and then perform an offset operation. In this way, the less information of the offset subsections may be transmitted in the bitstream. In particular, all the information of the offset subsections may not be transmitted. Three types of the method will be described with reference to the following two embodiments.

### Embodiment 8

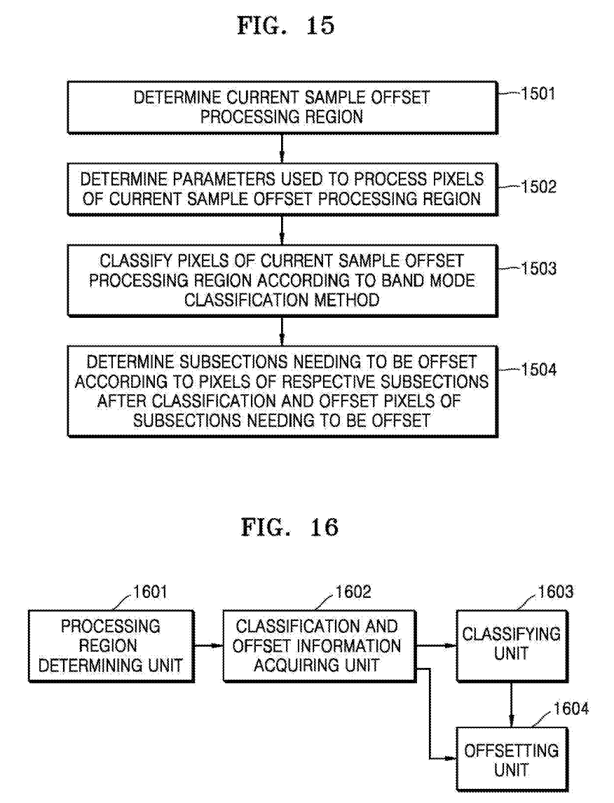

FIG. 15 is a basic flow diagram illustrating an embodiment of the present disclosure. As illustrated in FIG. 15, the flow may include the following process.

In operation 1501, the current sample offset processing region may be determined.

The methods of Embodiments 1 to 7 may be used, and the methods of the conventional technology not described herein may also be used.

In operation 1502, parameters used to process the pixels of the current sample offset processing region may be determined.

The parameters may include a pixel classification method and offset values. The encoder may select the classification method and the offset values according to the actual requirements and may specify the corresponding adopted parameters in the bitstream. The decoder may decode the corresponding classification method and the offset values from the bitstream.

In operation 1503, the pixels of the current sample offset processing region may be classified according to the band mode classification method.

The pixels of the current sample offset processing region may be classified according to the pixel classification method determined in operation 1502. The determined pixel classification method may be the band mode classification method. Specifically, a possible band mode classification method may include an operation of dividing a range of values of pixels into N subsections and an operation of determining a subsection including the current pixel according to the value of the current pixels. If the range of values of pixels is from 0 to max−1, the range of k^{th} subsections is from

$$k \times \frac{max}{N} to \frac{( k + 1 ) \times max}{N} - 1.$$

When the value of the current pixel is greater than or equal to

$$k \times \frac{max}{N}$$

and smaller than or equal to

$$\frac{( k + 1 ) \times max}{N} - 1 ,$$

the current pixel may belong to the subsection “k”, for example, the category “k”.

In operation 1504, the subsections needing to be offset may be determined according to the pixels of each subsection after the classification, and the pixels of the subsections needing to be offset may be offset.

Specifically, a possible method may include an operation of selecting four subsections including the most pixels among the N subsections as the subsections needing to be offset, an operation of adding the offset values corresponding to the pixels of the four subsections, and an operation of maintaining the pixels in an unchanged state. In this way, only four offset values may need to be transmitted in the bitstream, and information of the offset subsections may not need to be transmitted.

The order of operation 1501 and operation 1502 may vary according to embodiments.

### Embodiment 9

The basic flow of an embodiment of the present disclosure will be described with reference to FIG. 15. As illustrated in FIG. 15, the method of the embodiment of the present disclosure may include the following process.

In operation 1501, the current sample offset processing region may be determined.

The methods of Embodiments 1 to 7 may be used, and the other methods of the conventional technology not described herein may also be used.

In operation 1502, parameters used to process the pixels of the current sample offset processing region may be determined.

The parameters may include a pixel classification method and offset values. The encoder may select the classification method and the offset values according to the actual requirements and may specify the corresponding adopted parameters in the bitstream. The decoder may decode the corresponding classification method and the offset values from the bitstream.

In operation 1503, the pixels of the current sample offset processing region may be classified according to the band mode classification method.

The pixels of the current sample offset processing region may be classified according to the pixel classification method determined in operation 1502. The determined pixel classification method may be the band mode classification method. Specifically, a possible band mode classification method may include an operation of dividing a range of values of pixels into N subsections and an operation of determining a subsection including the current pixel according to the value of the current pixels. The above range may be divided uniformly or non-uniformly into N subsections, and the adopted division method may be specified in the system or the standard.

In operation 1504, the subsections needing to be offset may be determined according to the pixels of each subsection after the classification, and the pixels of the subsections needing to be offset may be offset.

Specifically, a possible method may include an operation of determining the subsections needing to be offset according to the pixels of the N subsections after the classification. Specifically, the method used in an embodiment of the present disclosure may include an operation of selecting the subsection L including the most pixels from the N subsections, an operation of determining the offset subsections according to Table 3, an operation of transmitting an indication representing the offset subsections in the bitstream, an operation of offsetting the pixels of the offset subsections, and an operation of maintaining the remaining pixels in an unchanged state. In this way, the information of the offset subsection may be transmitted in the bitstream, but the number of information-only bits may decrease rapidly.

The order of operation 1501 and operation 1502 may vary according to embodiments.

TABLE 3
Method of Determining Offset Subsections in Embodiment 9

| Indication of Offset Subsection in Bitstream | Offset Subsection Index |
|---|---|
| 0 | L − 3, L − 2, L − 1, L |
| 1 | L − 2, L − 1, L, L + 1 |
| 2 | L − 1, L, L + 1, L + 2 |
| 3 | L, L + 1, L + 2, L + 3 |

The present disclosure also provides three types of pixel processing apparatuses for implementing three types of pixel processing methods of the present disclosure. The detailed structures of the three types of pixel processing apparatuses may be basically identical, but the functions of some modules may be different. FIG. 16 is a schematic diagram illustrating a basic structure of the pixel processing apparatus. As illustrated in FIG. 16, the apparatus may include a processing region determining unit 1601, a classification and offset information acquiring unit 1602, and a classifying unit 1603, and an offsetting unit 1604.

The processing region determining unit 1601 may determine the current sample offset processing region according to the standards and/or the specifications in the bitstream.

The classification and offset information acquiring unit 1602 may classify the pixels of the current sample offset region and determine the information needing to be offset. Specifically, in the decoder, the classification and offset information acquiring unit 1602 may acquire the pixel classification information and the offset information from the bitstream; and in the encoder, the pixel classification information and the offset information may be determined according to the actual requirements. Preferably, in order to select the pixel classification method, the encoder may calculate the rate-distortion cost and the offset values according to the values of the original pixels and the values of the reconstructed pixels of the current sample offset processing region.

The classifying unit 1603 may classify the pixels of the current offset processing region. The classifying unit 1603 may classify the pixels of the region determined by the processing region determining unit 1601 according to the classification information acquired by the classification and offset information acquiring unit 1602. More specifically, the values of the pixels needing to be classified in a classification method (including the adjacent pixels and the pixels of the current region) may be first acquired, and a classification operation may be performed according to the classification method.

The offsetting unit 1604 may be used to offset the pixels to be processed in the current sample offset processing region. In order to acquire the processed pixel values, the offsetting unit 1604 may perform an offset operation for the pixels of the region determined by the processing region determining unit 1601 according to the classification information acquired by the classification and offset information acquiring unit 1602 and the classification result acquired by the classifying unit 1603.

More specifically, the processing region determining unit 1601 corresponding to the first type of the pixel processing method may perform the spatial position movement operation for the predetermined coding processing units and determine the region after the movement operation as the current sample offset processing region; or the processing region determining unit 1601 corresponding to the second type of the pixel processing method may determine the current sample offset processing region according to the region information transmitted in the bitstream. Also, for the third type of the pixel processing method, certain methods for the current sample offset processing region may be adopted, and any specification may not be made in the present disclosure.

For the classification and offset information acquiring unit 1602, the classifying unit 1603, and the offsetting unit 1604 corresponding to the first type and the second type of the pixel processing methods, the above classification and offset method may be used or other possible classification and offset methods may be used, and the present disclosure is not limited thereto.

According to the third type of the pixel processing method, the classifying unit 1603 and the offsetting unit 1604 may perform a classification operation and an offset operation in the third type of the pixel processing method. Specifically, the classifying unit 1603 may perform the classification operation according to the band mode classification method; and the offsetting unit 1604 may determine the M subsections needing to be offset according to the pixels of the current sample offset processing region and perform the offset operation for the pixels of the M subsections.

More specifically, the offsetting unit 1604 may be further used to determine the M subsections needing to be offset according to the pixels included in the respective subsections after the classification. Preferably, the M subsections including the most pixels of all the subsections after the classification may be selected as the M subsections needing to be offset.

Alternatively, the offsetting unit 1604 may be further used to determine the M subsections needing to be offset according to the offset subsection selection information specified in the bitstream and the pixels included in each subsection after the classification. Preferably, the subsections needing to be offset may be determined according to the offset subsection selection information specified in the bitstream and the subsection including the most pixels of all the subsections after the classification.

When the third type of the pixel processing method of the present disclosure is used, the information of the offset subsections needing to be transmitted in the bitstream may be rapidly saved in comparison with the method in the HEVC, and the information of the offset values may be saved in comparison with the method in which all the subsections are offset. Thus, the third type of the pixel processing method of the present disclosure may save the bit rate and improve the encoding performance in comparison with the conventional technologies.

When the first type and the second type of the processing methods of the present disclosure are used, the sample offset processing regions may be more flexible. The sample offset processing regions may include a prediction unit, a prediction unit group, a transformation unit, a transformation unit group, a coding unit, a coding unit group, a largest coding unit, a largest coding unit group, a slice, or an image, or may include a moved prediction unit, a moved prediction unit group, a moved transformation unit, a moved transformation unit group, a moved coding unit, a moved coding unit group, a moved largest coding unit, a moved largest coding unit group, or a certain region.

For the sample offset processing regions acquired by the movement, the present disclosure may sufficiently consider the boundary problems of the slice or the image. For example, when the sample offset processing region exceeds the boundaries of the slice or the image, it may be automatically reduced inside the slice or the image. For the region not included by a sample offset processing region, it may be merged into the adjacent sample offset processing region. For example, the sample offset processing region acquired by moving the coding processing unit from the boundary of the slice or the image to the inside of the slice or the image may be expanded to the boundary of the slice or the image, or the sample offset processing region may constitute a new processing region, or the pixels of the sample offset processing region may not be processed.

In the deblocking filtering process, the bottom boundary pixels and the right boundary pixels of the current block may not be filtered in the current block filtering process. Thus, the region acquired by moving the several pixels of the current block to the top left side may be determined as the current sample offset processing region coinciding with the deblocking filtering region of the current block. This may significantly reduce the implementation complexity and may effectively improve the encoding performance.

The above descriptions merely correspond to exemplary embodiments of the present disclosure, and various modifications, equivalents, substitutions, and/or improvements may be made therein without departing from the spirit and principle of the present disclosure.

1. A method of processing pixels in video encoding and decoding, the method comprising:
performing a spatial position movement operation for a predetermined coding processing unit and determining the spatial position movement operation as a current sample offset processing region; and
performing classification and offset operations for pixels of the current sample offset processing region.

2. The method of claim 1, wherein
when the current sample offset processing region exceeds a boundary of a slice or an image, the current sample offset processing region is reduced inside the boundary of the slice or the image and the classification and offset operations are performed;
when the current sample offset processing region is determined to be acquired by moving a coding processing unit of the boundary of the slice or the image to an inside of the slice or the image, the current sample offset processing region is expanded to the boundary of the slice or the image; and/or
when the current sample offset processing region is determined to be acquired by moving the coding processing unit of the boundary of the slice or the image to the inside of the slice or the image, the current sample offset processing region is maintained in an unchanged state and a pixel region between the boundary of the slice or the image and the current sample offset processing region is determined as a region where the classification and offset operations are not performed or as an independent sample offset processing region where the classification and offset operations are performed.

3. The method of claim 1, wherein the predetermined coding processing unit is a prediction unit group, a transformation unit, a transmission unit group including several adjacent transformation units, a coding unit, a coding unit group including several adjacent coding units, a largest coding unit, or a largest coding unit group including largest coding units.

4. The method of claim 1, wherein
the predetermined coding processing unit is determined by a standard or a system or is transmitted in a bitstream;
a movement direction in the spatial position movement operation is determined by the standard or the system or is transmitted in the bitstream; and/or
a movement distance in the spatial position movement operation is determined by the standard or the system or is transmitted in the bitstream.

5. The method of claim 1, wherein the performing of the classification operation for the pixels of the current sample offset processing region comprises:
dividing a range of pixel values into N subsections; and
classifying current pixels of a category corresponding to a subsection k in which a value of the current pixel is located,
wherein N is a predetermined positive integer and k is an index of the subsection.

6. The method of claim 1, wherein the performing of the classification operation for the pixels of the current sample offset processing region comprises:
comparing a value of a current pixel and some or all of adjacent pixels of the current pixel; and
determining a category of the current pixel according to a result of the comparing.

7. The method of claim 1, wherein the performing of the offset operation for the pixels of the current sample offset processing region comprises adding an offset value to pixels of a category according to the category of the pixels.

8. The method of claim 7, wherein the performing of the offset operation for the pixels of the current sample offset processing region comprises calculating the offset value corresponding to the category according to a predetermined calculation method based on an offset reference value.

9. The method of claim 1, determining the spatial position movement operation further comprises determining the current sample offset processing region according to region information transmitted in a bitstream.

10. The method of claim 9, wherein an encoder and a decoder determine several region division methods for a coding processing unit and allocate an index to each region division method, and the region information transmitted in the bitstream is the index of the region division method selected by the encoder.

11. A method of processing pixels in video encoding and decoding, the method comprising:
determining a current sample offset processing region; and
performing classification and offset operations on pixels of the current sample offset processing region,
wherein
the performing of the classification operation comprises dividing a range of values of pixels into N subsections and classifying a current pixel as a category corresponding to a k subsection in which a value of the current pixel is located, where N is a predetermined positive integer and k is an index of the subsection; and
the performing of the offset operation comprises determining M subsections needing to be offset according to the pixels of the current sample offset processing region and offsetting the pixels of the M offset subsections.

12. The method of claim 11, wherein the subsections needing to be offset are determined according to the pixels included in all the subsections after the classification.

13. The method of claim 12, wherein the determining of the subsections needing to be offset according to the pixels included in all the subsections after the classification comprises selecting M subsections including the most pixels after the classification among all the subsections as the offset subsections.

14. The method of claim 11, wherein the subsections needing to be offset are determined according to the pixels included in all the subsections after the classification and information transmitted in a bitstream.

15. The method of claim 14, wherein the subsections needing to be offset are determined according to a subsection including the most pixels of all the subsections after the classification and information on an offset subsection selection method appearing on the bitstream.

16. An apparatus for processing pixels in video encoding and decoding, the apparatus comprising:
a processing region determining unit configured to perform a spatial position movement operation for a predetermined coding processing unit and determining a region after the spatial position movement operation as a current sample offset processing region;
a classification and offset information acquiring unit configured to acquire a pixel classification method and corresponding offset values;
a classifying unit configured to classify each pixel of the current sample offset processing region according to the pixel classification method determined by the classification and offset information acquiring unit; and
an offsetting unit configured to offset the pixels according to the offset values and a result of the classifying by the classifying unit.

17. The apparatus of claim 16, further comprising a processing region modifying unit configured to, when the current sample offset processing region exceeds a boundary of a slice or an image, reduce the current sample offset processing region determined by the processing region determining unit inside the boundary of the slice or the image and notify the same to the classifying unit and the offsetting unit.

18. The apparatus of claim 16, further comprising a processing region modifying unit configured to:
when the current sample offset processing region is acquired by moving a coding processing unit at a boundary of a slice or an image to an inside of the slice or the image, expand the current sample offset processing region determined by the processing region determining unit to the boundary of the slice or the image and notify the same to the classifying unit and the offsetting unit; or
when the current sample offset processing region is acquired by moving the coding processing unit at the boundary of the slice or the image to the inside of the slice or the image, maintain the current sample offset processing region determined by the processing region determining unit in an unchanged state and notifying the classifying unit and the offsetting unit that sample offset processing is not performed for pixels of a region between the boundary of the slice or the image and a boundary of the current sample offset processing region or notify the classifying unit and the offsetting unit that the region between the boundary of the slice or the image and the boundary of the current sample offset processing region is determined as an independent sample offset processing region.

19. The apparatus of claim 16, wherein the processing region determining unit configured to determine the current sample offset processing region according to region information transmitted in a bitstream.

20. The apparatus of claim 16,
wherein the classifying unit configured to divide a range of values of pixels into N subsections and classify a current pixel as a category corresponding to a subsection k in which a value of the pixel is located, where N is a positive integer and k is an index of the subsection; and
wherein the offsetting unit configured to determine M subsections needing to be offset according to the pixels of the current sample offset processing region and offset the pixels of the M offset subsections.
